(19) United States
(12) Patent Application Publication
(10) Pub. No.: US 2006/0037655 A1
(43) Pub. Date: Feb. 23, 2006

(54) Three-way valve with independent quarter-turn outlets

(76) Inventor: Jose Maria Ferrer Beltran, Foios (ES)

Correspondence Address: JACOBSON HOLMAN PLLC, 400 SEVENTH STREET N.W., SUITE 600, WASHINGTON, DC, 20004, US

(21) Appl. No.: 10/919,482

(22) Filed: Aug. 17, 2004

(51) Int. Cl. F16K 11/087

(52) U.S. Cl. 137/625.46

(57) ABSTRACT

The “three-way valve, with independent quarter-turn outlets”, which constitutes the object of this patent, and whose main use is as expressed in the title of the invention, is of the type where the inlet channel is between the two outlet channels, which are aligned orthogonally to the longitudinal axis of the inlet channel in a general T-shaped layout.

The central valve (2) receives the fluid from below and is capable of distributing it as desired to one or both sides simultaneously. For this purpose, its plug (3) has a straight interior channel (4) and an L-shaped channel (5), with perpendicular outlet directions, in such a way that the straight channel (4) lets the fluid use both outlets simultaneously, whereas the L-shaped channel (5) enables only one unidirectional flow towards the outlet channel (6) in which the lateral valve (7) is inserted.

The lateral valve (7), receives the flow from the side, transversally, and is capable of regulating the flow in the outlet channel (6) in which it intervenes, for the purpose of which its plug (8) has a straight interior channel (9).

### OBJECT

The object of the invention of this patent consists of a “three-way valve, with independent quarter-turn outlets.”

### BACKGROUND

Three-way valves are widely known devices for the regulation of the flow of liquid fluids, which include in one same body or box two independent valves set in such a way that, with one single inlet and two outlets, of equal or different diameters, they enable the separate control of the outlet flows of both sections.

The relative positions of the valves may vary, depending in turn on that taken by the inlet channel with regard to the outlet channels, since it can take up an intermediate position between both, or a position in one of the lateral channels.

Whatever the case, three-way valves must be able to take up four alternative functional positions:
Both outlets open simultaneously.
One outlet open and the other closed.
That same status but the other way around (closed-open).
Both outlets closed simultaneously.

A preferred application of three-way valves is the connection of domestic appliances (washing machines, dish-washers) and taps simultaneously to the water mains at one single inlet.

### DESCRIPTION OF THE INVENTION

The purpose of the invention that is the object of this patent consists of the engineering and production of a three-way valve with which the functional performance typical of said valves and common to all is obtained, by means of a quarter-turn flow control system on both outlets of each of the two independent valves integrated in it. The three-way valve claimed has been expressly designed and developed in accord with this objective, since the valve-machining for quarter-turn control systems is simpler and cheaper than the spindle system.

Said three-way valve is of the type with the inlet port between the two outlet ports, which are aligned orthogonally to the longitudinal axis of the inlet port in a general T-shaped layout.

One of the two independent valves is aligned axially with the tubular inlet channel that constitutes the central longitudinal section of the “T” (central valve), while the axis of the other valve is perpendicular to the longitudinal axis of one of the two tubular outlet channels, which make up the transverse section of the “T” (lateral valve). Both are grouped together in one single technical unit (three-way valve).

The valve aligned with the inlet channel, the central valve, receives the fluid from below and is capable of distributing it as desired to one or both sides simultaneously. For this purpose, that valve's plug has a straight interior channel and an L-shaped channel, with perpendicular outlet directions, in such a way that the straight channel lets the fluid use both outlets simultaneously, whereas the L-shaped channel provides only one unidirectional flow towards the outlet channel in which the lateral valve is inserted.

The valve set orthogonally to one of the outlet channels, the lateral valve, receives the flow from the side, transversally, and is capable of regulating the flow in the outlet channel in which it intervenes, for which purpose its plug has a straight interior channel.

The structures of the two independent valves, the central and lateral valves, correspond substantially to the generally known structure typical of fluid regulation valves with ellipsoidal plugs. Therefore, between said particular structures, there is both formal and functional similarity, except with regard to the fluid-flow through their respective plugs, the distinctive features of which have been previously described.

However, they do have differences of size and form resulting from the fact that their assembly is necessarily different since, whereas in the central valve the plug stem is assembled by introducing the unit through the bottom of the main body of the three-way valve, the lateral valve can be assembled through the top of the body only, i.e. through the housing neck.

The functioning of the claimed three-way valve, in order to fulfil the four alternative functional options required of it, includes the following simultaneous positioning of its respective interior channels:
Both outlets open.
   Central valve: L-shaped channel closed and straight channel open.
   Lateral valve: Straight channel open.
Single outlet through the channel with the lateral valve.
   Central valve: L-shaped channel open and straight channel closed.
   Lateral valve: Straight channel open.
Single outlet through the lateral channel with no valve.
   Central valve: L-shaped channel closed and straight channel open.
   Lateral valve: Straight channel closed.
Both outlets closed.
   Central valve: L-shaped channel open and straight channel closed.
   Lateral valve: Straight channel closed.

In the above positional descriptions, the word “open” is applied to the channel through whose interior the fluid flows, whereas, reciprocally, the word “closed” is applied to the channel in a position where the fluid cannot flow through its interior.

### BRIEF DESCRIPTIONS OF THE DRAWINGS

In order to complement the description of the invention and facilitate interpretation of the formal, structural and functional features of its object, diagrams are attached showing different features of a preferred embodiment of the “three-way valve, with independent quarter-turn outlets” that is the object of this patent. In said diagrams:

FIG. 1 shows a perspective view of the longitudinal section of the claimed three-way valve with the position of the controls of its independent valves enabling the simultaneous outlet of the fluid through its two lateral channels;

FIG. 2 with a single outlet through the channel in which the lateral valve is inserted;

FIG. 3 with a single outlet through the lateral channel with no valve; and

FIG. 4 with both lateral channels closed.

FIG. 5 is a perspective view of the plug-stem unit of the lateral valve; and

FIG. 6 is a longitudinal and axial section of said unit.

FIG. 7 is a perspective view of the plug-stem unit of the central valve; and

FIG. 8 is a longitudinal and axial section of said unit.

### DESCRIPTION OF A PREFERRED EMBODIMENT

To clearly show the nature and scope of the advantageous application of the “three-way valve, with independent quarter-turn outlets” that constitutes the object of the claimed invention, the following is a description of its structure and functioning, with reference to the diagrams which, as they represent a preferred embodiment of said object, for information purposes, must be considered in their widest sense and not as limiting to the application and content of the claimed invention.

Said three-way valve is of the type with the inlet channel between the two outlet channels, which are aligned orthogonally to the longitudinal axis of the inlet valve in a general T-shaped layout.

One of the two independent valves is aligned axially with the tubular inlet channel that constitutes the central longitudinal section of the “T” (central valve), while the axis of the other valve is perpendicular to the longitudinal axis of one of the two tubular outlet channels, which make up the transverse section of the “T” (lateral valve) . Both are grouped together in one single technical unit (three-way valve).

The valve aligned with the inlet channel (1), the central valve (2), receives the fluid from below and is capable of distributing it as desired to one or both sides simultaneously. For this purpose, its plug (3) has a straight interior channel (4) and an L-shaped channel (5), with perpendicular outlet directions, in such a way that the straight channel (4) lets the fluid use both outlets simultaneously, whereas the L-shaped channel (5) enables only one unidirectional flow towards the outlet channel (6) in which the lateral valve (7) is inserted.

The orthogonal valve to one of the outlet channels (6), the lateral valve (7), receives the flow from the side, transversally, and is capable of regulating the flow in the outlet channel (6) in which it intervenes, for the purpose of which its plug (8) has a straight interior channel (9).

The structures of the two independent valves, the central (2) and lateral (7) valves, correspond substantially to the general known structure typical of fluid regulation valves with ellipsoidal plugs. Therefore, between said particular structures, there is both formal and functional similarity, except with regard to the fluid flowing through their respective plugs, whose distinctive features have been previously described.

However, they do have differences of size and form resulting from the fact that their assembly is necessarily different since, whereas in the central valve (2) the plug stem is assembled by introducing the unit through the bottom of the main body of the three-way valve, the lateral valve (7) can be assembled through the top of the body only, i.e. through the housing neck.

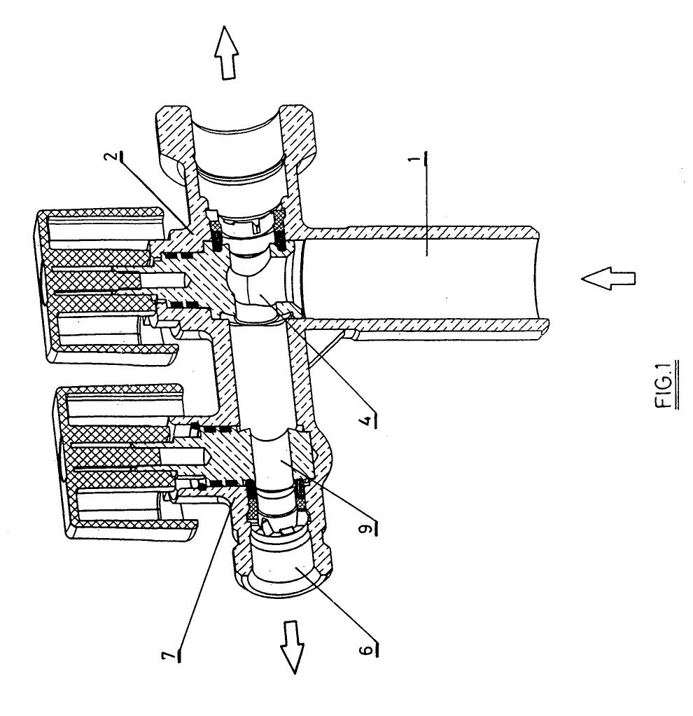

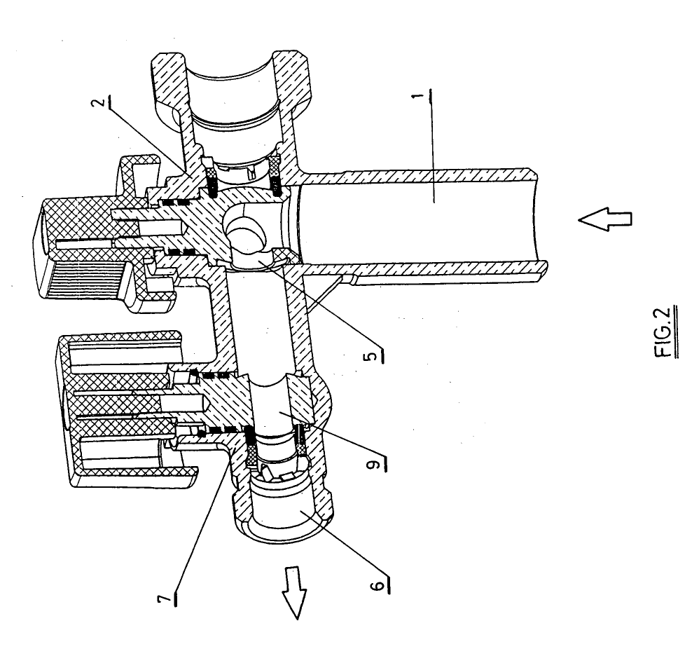

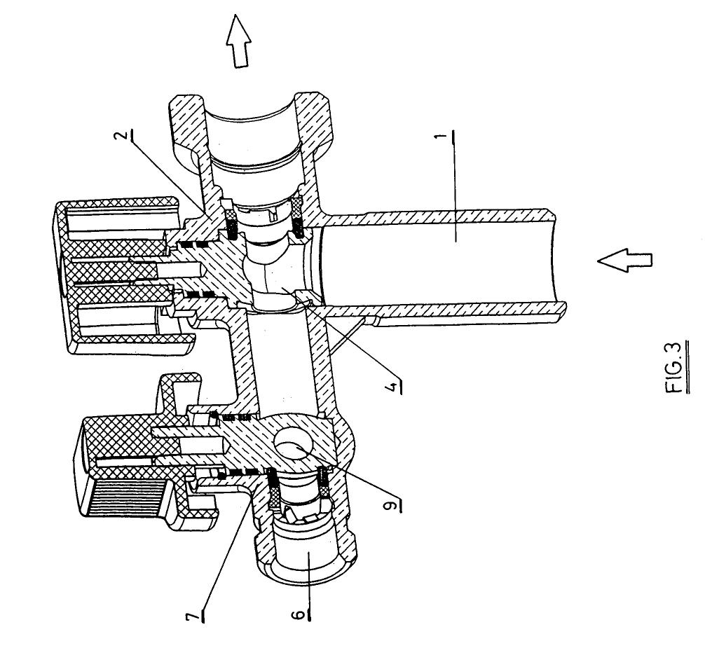

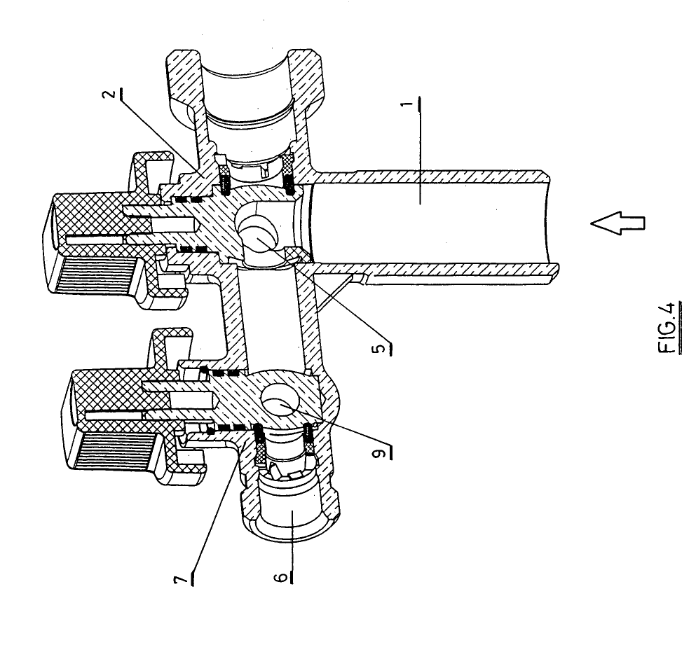

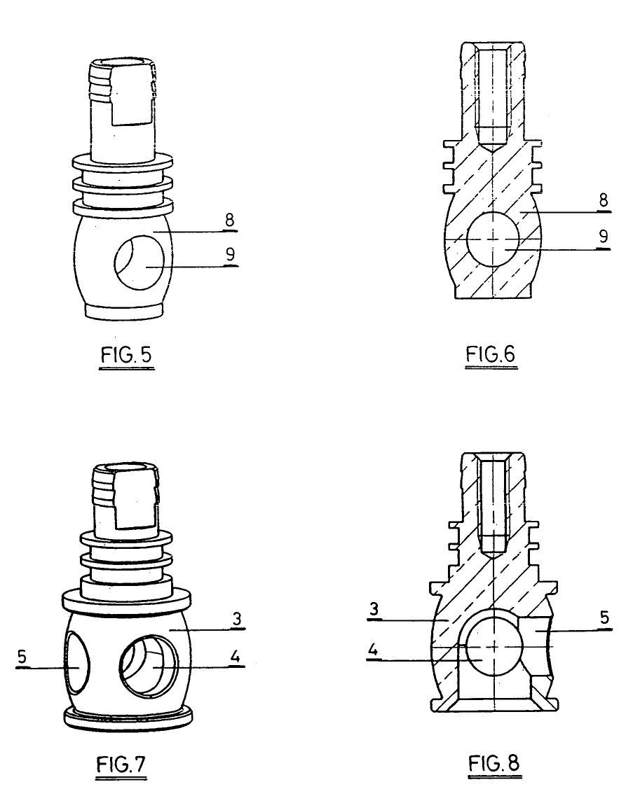

The functioning of the claimed three-way valve, in order to fulfil the four alternative functional options required of it, includes the following simultaneous positioning of its respective interior channels:
Both outlets open. (See FIG. 1)
   Central valve: L-shaped channel closed and straight channel open.
   Lateral valve: Straight channel open.
Single outlet through the channel (6) with the lateral valve (7): (See FIG. 2)
   Central valve: L-shaped channel open and straight channel closed.
   Lateral valve: Straight channel open.
Single outlet through the lateral channel with no valve. (See FIG. 3)
   Central valve: L-shaped channel closed and straight channel open.
   Lateral valve: Straight channel closed.
Both outlets closed. (See FIG. 4)
   Central valve: L-shaped channel open and straight channel closed.
   Lateral valve: Straight channel closed.

In the above positional descriptions, the word “open” is applied to the channel through whose interior the fluid flows, whereas, reciprocally, the word “closed” is applied to the channel in a position where the fluid cannot flow through its interior.

1: Three-way valve, with independent quarter-turn outlets, of the type that have the inlet channel between the two outlet channels, which are aligned orthogonally to the longitudinal axis of the inlet channel, in a general T-shaped layout, characterised in that one of the two independent valves is aligned axially with the tubular inlet channel, which constitutes the central longitudinal section of the “T” (central valve), whereas the other valve has its axis perpendicular to the longitudinal axis of one of the two tubular outlet channels that constitute the transversal section of the “T” (lateral valve), where both are contained in and constitute one single technical unit (three-way valve).

2: Three-way valve, with independent quarter-turn outlets, as set forth in claim number 1, characterised in that the valve aligned with the inlet channel (1), the central valve (2), receives the fluid from below and is capable of distributing it as desired to one or both sides simultaneously. For this purpose, its plug (3) has a straight interior channel (4) and an L-shaped channel (5), with perpendicular outlet directions, in such a way that the straight channel (4) lets the fluid use both outlets simultaneously, whereas the L-shaped channel (5) enables only one unidirectional flow towards the outlet channel (6) in which the lateral valve (7) is inserted.

3: Three-way valve, with independent quarter-turn outlets, as set forth in claim 1, characterised in that the orthogonal valve to one of the outlet channels (6), the lateral valve (7), receives the flow from the side, transversally, and is capable of regulating the flow in the outlet channel (6) in which it intervenes, for the purpose of which its plug (8) has a straight interior channel (9).
